(19) United States
(12) Patent Application Publication
(10) Pub. No.: US 2015/0296885 A1
(43) Pub. Date: Oct. 22, 2015

(54) ATOMIZATION TEMPERATURE CONTROLLABLE ELECTRONIC CIGARETTE

(71) Applicant: QIUMING LIU, Shenzhen City, Guangdong Province (CN)

(72) Inventor: QIUMING LIU, Shenzhen City, Guangdong Province (CN)

(21) Appl. No.: 14/235,044

(22) PCT Filed: Apr. 7, 2013
(86) PCT No.: PCT/CN2013/073834

§ 371 Date: Jan. 24, 2014

(51) Int. Cl. A24F 47/00; H05B 1/02

(52) U.S. Cl. CPC A24F 47/008; H05B 1/0244

(57) ABSTRACT

The present invention provides an atomization temperature controllable electronic cigarette including an inhalation nozzle, an atomization device, and a power supply pole. The atomization device has a heater disposed therein. The power pole has a power, a control switch, and an atomization control unit. The atomization device has a temperature sensor disposed therein. The electronic cigarette further includes a temperature signal processing unit electrically connected with the temperature sensor and the temperature signal processing unit. The control switch controls connection and disconnection between the atomization control unit, the temperature signal processing unit and the power. The atomization temperature in the atomization chamber of the present electronic cigarette maintains in a preset temperature range such that the atomization effect of the electronic cigarette is improved and taste is enhanced to be more likely to real smokes.

### FIELD OF THE INVENTION

The present invention relates to the electronic cigarette field, and more particularly, to a kind of atomization temperature controllable electronic cigarette.

### BACKGROUND OF THE INVENTION

Currently, electronic cigarette is mainly controlled directly by an MCU module to control a heater in an atomization device for heating and atomizing the smoke liquid. A microprocessor cannot adjust the temperature of the atomized smoke oil in an atomizer promptly. The atomization temperature will continue to rise due to the temperature of the heater, and it could be changed constantly by a few affects such as an ambient temperature, the quantity of the smoke oil and a change of a battery charge. Thereby, it could affect the atomization effect of the atomization device and taste of the electronic cigarette.

### SUMMARY OF THE INVENTION

An object of the present invention is to provide an atomization temperature controllable electronic cigarette to improve the atomization effect of the atomization device of the electronic cigarette, and make the taste of the electronic cigarette more likely to real smokes.

To achieve the above-mentioned object, the present invention provides an atomization temperature controllable electronic cigarette including an inhalation nozzle, an atomization device, and a power supply pole. The atomization device has a heater disposed therein. The power supply pole has a power, a control switch, and an atomization control unit. The atomization device further has a temperature sensor disposed therein. The electronic cigarette further includes a temperature signal processing unit electrically connected with the temperature sensor and the temperature signal processing unit. The control switch controls connection and disconnection between the power and the atomization control unit, the temperature signal processing unit.

In a further embodiment, the temperature sensor is disposed in an airflow channel in the atomization device, or is disposed in a middle or two ends of the heater, or is disposed on the tube wall inside the atomization device.

In a further embodiment, the temperature sensor is a thermocouple, a positive temperature coefficient thermistor, or a resistance temperature detector.

In a further embodiment, the atomization control unit is disposed in the power supply pole, and integrated on a same control circuit board with the temperature signal processing unit, or the atomization control unit is disposed in the atomization device.

In a further embodiment, inputs of the control switch are electrically connected with the power, and outputs of the control switch are respectively electrically connected with the atomization control unit and the temperature signal processing unit so as to control connection and disconnection between the atomization control unit, the temperature signal processing unit and the power.

In a further embodiment, the control switch is a sensor switch, an airflow sensor switch, a button switch, a rotary switch, or a slide switch.

In a further embodiment, the atomization device and the power supply pole are connected with each other by the way of latching, inserting connection, screw-threaded connection or magnetic attraction; or the atomization device and the power supply pole are integrated structure.

In a further embodiment, the atomization device is substantially hollow cylindrical shape, and forms an atomization chamber therein. The atomization device further includes a smoke liquid cup for storing smoke liquid, a liquid guiding assembly used to guide the smoke liquid from the smoke liquid cup into the atomization chamber, and a liquid storage assembly for absorbing and storing smoke liquid from the liquid guiding assembly into the atomization chamber.

In a further embodiment, the heater is an electric heating wire wrapping around the fiber component, and is securely fixed in the atomization device by the fiber component.

With the application of the above-mentioned technical program, the magnetic connection electronic cigarette with a connector of the present invention has the following benefits: by setting the temperature sensor and the temperature signal processing unit in the electronic cigarette, which feedbacks the atomization temperature to the atomization control unit to control the heating power of the heater and remain the atomization temperature within the preset temperature range, the atomization effect of the atomization device is improved and the taste of the electronic cigarette is more likely to real smokes.

Embodiments of the present invention will be further described in detail in the following drawings.

### BRIEF DESCRIPTION OF THE DRAWINGS

FIG. 1 is a main view of an atomization temperature controllable electronic cigarette of an embodiment of the present invention.

FIG. 2 is a structure diagram of the atomization temperature controllable electronic cigarette of the embodiment of the present invention.

### DETAILED DESCRIPTION OF THE INVENTION

It is needed to state that embodiments and all element limitations in all embodiments may be combined in the case of no conflicts. The present invention will be described in detail in the following combining figures and embodiments.

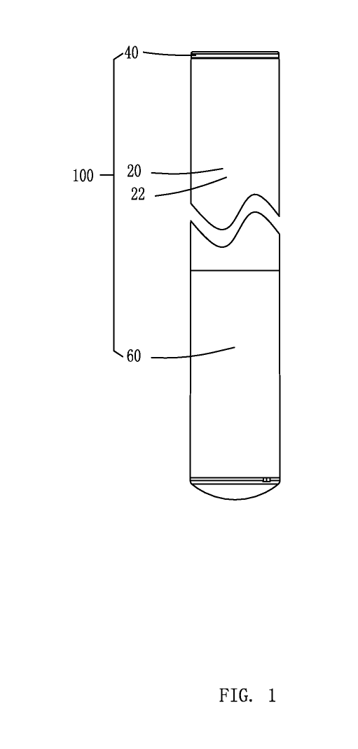

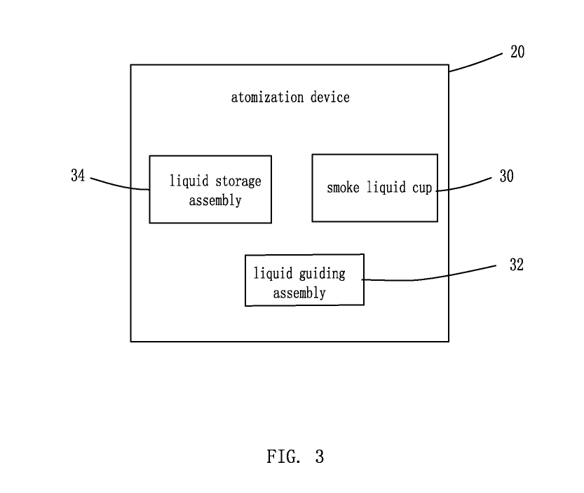

Referring to FIG. 1 and FIG. 2, an embodiment of the present invention provides an atomization temperature controllable electronic cigarette 100. The electronic cigarette 100 includes an atomization device 20, an inhalation nozzle 40 and a power supply pole 60. The inhalation nozzle 40 and the power supply pole 60 locate at two ends of the atomization device 20 respectively. The atomization device 20 and the power supply pole 60 are connected by any feasible way such as latching, inserting connection, screw-threaded connection or magnetic attraction. Certainly, the atomizing device 20 and the power supply pole 60 also may be an integrated structure.

The inhalation nozzle 40 could be a nozzle of any structure, only the structure thereof can be coordinated with the atomization device 20.

The atomization device 20 is substantially hollow cylindrical shape. The atomization device 20 includes a heater 26, a temperature sensor 28, and a smoke liquid cup (not shown) for smoke liquid storage, a liquid guiding assembly (not shown), a liquid storage assembly (not shown) and so on, and forms an atomization chamber (not shown). The smoke liquid cup is used for smoke liquid storage. The liquid guiding assembly is made of cotton or fabric material, and is used to guide the smoke liquid from the smoke liquid cup into the atomization chamber. The liquid storage assembly can absorb and store liquid like a sponge, and is used to absorb and store smoke liquid from the liquid guiding assembly into the atomization chamber such that the heater 26 atomizes the smoke liquid. One end of the liquid guiding assembly extends into the smoke liquid cup, and the other end of the liquid guiding assembly extends into the atomization chamber and abuttingly connects with the smoke liquid storage assembly to make the smoke liquid penetrate into the liquid storage assembly and absorbed by the fiber component. The smoke liquid cup, the liquid guiding assembly, the liquid storage assembly, and the atomization chamber can be adapted as any feasible existing structure or equivalents thereof, therefore no repeat here.

The heater 26 is an electric heating wire wrapping around the fiber component (not shown), and securely fixed in the atomization device 20 by the fiber component. The specific structure of the heater 26 and the fiber component is not limited, and could be any feasible existing structure or equivalents thereof, therefore no repeat here.

The temperature sensor 28 is disposed in the atomization device 20, for detecting atomization temperature in the atomization device 20. The temperature sensor 28 may be located in an airflow channel of the atomization device 20, or located in the middle or two ends of the heater 26, and also may be located on a tube wall (not shown) inside the atomization device 20, as long as it can detect the atomization temperature in the atomization device 20. The temperature sensor 28 may be a temperature detecting element such as a thermocouple, a positive temperature coefficient thermistor (PTC), or a Resistance Temperature Detectors (RTD) and so on. The Resistance Temperature Detectors (RTD) may be a wire, and also may be a thin film.

The power supply pole 60 is of hollow cylindrical shape approximately, and has a power 62, a control switch 64, an atomization control unit 66 and a temperature signal processing unit 68. The control switch 64 controls the turn-on or turn-off of the electronic cigarette 100. Preferably, the atomization control unit 66 and the temperature signal processing unit 68 are integrated on a same control circuit board (not shown).

The power 62 may be a rechargeable battery or a disposable battery, and supplies power to the atomization control unit 66, the temperature signal processing unit 68, and the heater 26 when the control switch 64 is turned on.

Inputs of the control switch 64 are electrically connected with the power 62, and outputs of the control switch 64 are electrically connected with the atomization control unit 66 and the temperature signal processing unit 68 respectively to control connection or disconnection between the atomization control unit 66, the temperature signal processing unit 68 and the power 62. The control switch 64, for example, is a sensor switch. Specifically, the control switch is a capacitive sensor switch. When users use the electronic cigarette 100 smoking, the capacitive sensor switch senses the capacitance change after sucking out of airflow, then makes the atomization control unit 66 and the temperature signal processing unit 68 connected to the power 62 so that the electronic cigarette 100 goes into working As an embodiment, the sensor switch also may be an airflow sensor switch. That is, when users use the atomization device 20 smoking to make a chamber of the electronic cigarette produce negative pressure, thus make the airflow sensor switch generates a pulse signal so as to make the atomization control unit 66 and the temperature signal control unit 68 connected to the power 62. The control switch 64 may also be set as a traditional button switch. Pressing the button switch is to connect and disconnect the atomization control unit 66, the temperature signal processing unit 68 and the power 62. The control switch 64 can also be set as any type of switch such as rotary switch, slide switch which can control the connection or disconnection connection or disconnection between the atomization control unit 66, the temperature signal processing unit 68 and the power 62.

Inputs of the temperature signal processing unit 68 are electrically connected to the output of the control switch 64 and the temperature sensor 28, and receives the temperature information sent from the temperature sensor 28 when power is supplying, then transfers the temperature information into corresponding control signal and transmits the control signal to the atomization control unit 66. As another embodiment, the temperature signal processing unit 68 also may be set at a prompt position inside the atomization device.

Inputs of the atomization control unit 66 are respectively electrically connected with the output of the control switch 64 and an output of the temperature signal processing unit 68, and receives the control signal sent from the temperature signal processing unit 68 when power is supplying. Outputs of the atomization control unit 66 are electrically connected with the heater 26, and controls the heating power of the heater 26 according to the control signal receiving from the temperature signal processing unit 68 so as to control the atomization temperature in the atomization chamber and make the atomization temperature in the atomization chamber maintaining in a preset temperature range such that the atomization effect of the electronic cigarette 100 is improved and taste is enhanced to be more likely to real smoke. Specifically, the atomization control unit 66 compares the receiving control signal with a stored data to judge whether the temperature in the atomization device 20 is in the preset temperature range. If the temperature in the atomization device 20 is lower than a minimum in the preset temperature range, the atomization control unit 66 controls the heater 26 to intermittently heat, or increase the heating power of the heater 26 by way of increasing the voltage at both ends of the heater 26 to make the temperature in the atomization device 20 rise to the preset temperature range. If the temperature in the atomization device 20 is higher than a minimum in the preset temperature range, the atomization control unit 66 controls the heater 26 to stop heating, or decrease the heating power of the heater 26 by way of decreasing the voltage at both ends of the heater 26 to make the temperature in the atomization device 20 reduce to the preset temperature range. Therefore, the atomization temperature in the atomization chamber can be always maintained in a preferable range to ensure the atomization effect of the atomization device 20.

In summary, the embodiments of the present invention provides an atomization temperature controllable electronic cigarette 100, which disposes a temperature sensor 28 in the atomization device 20 to detect the atomization temperature of the atomization device 20, and uses the temperature signal processing unit 68 to transfer the detected temperature information into corresponding control signal and feedback the control signal to the atomization control unit 66. The atomization control unit 66 controls the heating power of the heater 26 based on the received control signal to maintain the atomization temperature of the atomization device 20 within the preset temperature range. The atomization effect of the atomization device 20 is improved and the taste of the electronic cigarette 100 is more likely to real smokes.

Even though embodiments of the present invention is shown and described in the above-mentioned. It is needed to state that embodiments and all element limitations in all embodiments may be combined in the case of no conflicts. Various improvement and modifications can be made to the embodiments by those skilled in the art without departing from the true spirit and scope of the disclosure. The scope of the present invention is defined by the appended claims and equivalents thereof.

1. An atomization temperature controllable electronic cigarette comprising an inhalation nozzle, an atomization device, and a power supply pole, the atomization device having a heater disposed therein, the power supply pole having a power, a control switch, and an atomization control unit, wherein the atomization device further has a temperature sensor disposed therein, the electronic cigarette further includes a temperature signal processing unit electrically connected with the temperature sensor and the temperature signal processing unit, the control switch controls connection and disconnection between the atomization control unit, the temperature signal processing unit and the power.

2. According to the atomization temperature controllable electronic cigarette in claim 1, wherein the temperature sensor is disposed in an airflow channel in the atomization device, or is disposed in a middle or two ends of the heater, or is disposed on a tube wall inside the atomization device.

3. According to the atomization temperature controllable electronic cigarette in claim 1, wherein the temperature sensor is a thermocouple, a positive temperature coefficient thermistor, or a resistance temperature detector.

4. According to the atomization temperature controllable electronic cigarette in claim 1, wherein the atomization control unit is disposed in the power supply pole, and integrated on a same control circuit board with the temperature signal processing unit.

5. According to the atomization temperature controllable electronic cigarette in claim 1, wherein the atomization control unit is disposed in the atomization device.

6. According to the atomization temperature controllable electronic cigarette in claim 1, wherein inputs of the control switch are electrically connected with the power, and outputs of the control switch are respectively electrically connected with the atomization control unit and the temperature signal processing unit to control connection and disconnection between the atomization control unit, the temperature signal processing unit and the power.

7. According to the atomization temperature controllable electronic cigarette in claim 1, wherein the control switch is a sensor switch, a button switch, a rotary switch, or a slide switch.

8. According to the atomization temperature controllable electronic cigarette in claim 1, wherein the atomization device and the power supply pole are connected by the way of latching, inserting connection, screw-threaded connection or magnetic attraction.

9. According to the atomization temperature controllable electronic cigarette in claim 1, wherein the atomization device and the power supply pole are integrated structure.

10. According to the atomization temperature controllable electronic cigarette in claim 1, wherein the atomization device is substantially hollow cylindrical shape, and forms an atomization chamber, the atomization device further includes a smoke liquid cup for storing smoke liquid, a liquid guiding assembly used to guide the smoke liquid from the smoke liquid cup into the atomization chamber, and a liquid storage assembly for absorbing and storing smoke liquid from the liquid guiding assembly into the atomization chamber.

11. According to the atomization temperature controllable electronic cigarette in claim 1, wherein the heater is an electric heating wire wrapping around a fiber component, and is securely fixed in the atomization device by the fiber component.

12. According to the atomization temperature controllable electronic cigarette in claim 2, wherein the temperature sensor is a thermocouple, a positive temperature coefficient thermistor, or a resistance temperature detectors.

13. According to the atomization temperature controllable electronic cigarette in claim 6, wherein the control switch is a sensor switch, a button switch, a rotary switch, or a slide switch.

14. According to the atomization temperature controllable electronic cigarette in claim 13, wherein the sensor switch is an airflow sensor switch.

15. According to the atomization temperature controllable electronic cigarette in claim 7, wherein the sensor switch is an airflow sensor switch.
